(19) United States
(12) Patent Application Publication
(10) Pub. No.: US 2004/0240390 A1
(43) Pub. Date: Dec. 2, 2004

(54) Method and apparatus for dynamic bandwidth adaptation

(75) Inventor: Gamze Seckin, Mountain View, CA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Vidiator Enterprises Inc., Nassau (BS)

(21) Appl. No.: 10/452,035

(22) Filed: May 30, 2003

(51) Int. Cl. H04J 3/14; H04L 12/66; H04L 12/26

(52) U.S. Cl. 370/252; 370/349; 370/352

(57) ABSTRACT

A dynamic bandwidth adaptation (DBA) algorithm is provided, such as for RTP/UDP/IP-based 2.5 G and 3 G wireless streaming systems. The DBA algorithm enables steady streaming quality and smooth transitions during congestion and network resource fluctuation periods, by automatically adjusting the video or audio bit rate stream to suit a changing bandwidth of a channel. The DBA algorithm monitors the channel for statistically significant and persistent changes in the bandwidth that may be associated with packet loss, delay, or delay variation. When these changes occur and when there is an existing closely matching but lower bit rate stream, the streaming server switches over to that lower stream. Switching to a higher bit rate stream may also be performed. Base delay or delay variation tracking information is used to further determine, improve, and optimize bandwidth adaptation. Data from a pause event is not collected, thereby improving the statistical analysis and decision-making process related to actual streaming.

### BACKGROUND OF THE INVENTION

1. Field of the Invention

The present disclosure relates generally to wireless communication systems, and in particular but not exclusively, relates to techniques to optimize communication of wireless streaming data by monitoring bandwidth conditions and changing to appropriate bit rate streams in response to changes in the bandwidth conditions.

2. Description of the Related Art

With developments in media compression and wireless network infrastructures, media streaming has become a promising area of technology for end-users, content providers, wireless operators, and other entities. Although there will be more bandwidth available for wireless technologies such as 3 G and despite the fact that some of the advanced compression techniques enable very low-bit-rate streaming, there are inherent problems when it comes to the wireless environment.

Areas of wireless streaming applications where such problems are encountered include real-time media applications (including both audio and video streaming), real-time audio applications (such as live music or sports broadcasts), off-line media applications, and off-line audio applications. Unlike wired networks, wireless networks suffer from high rates of effective packet loss. Packet loss may be caused by factors such as network congestion, bit error rates, or data overflow at the user's device.

In addition to packet loss, packet delay is another problem that adversely affects the quality of the media received by the end user. Packet delay can be caused by a number of factors, including forward error correction and buffering during the communication process.

Typically in a wireless network, the amount of available bandwidth changes because of network conditions, number of users, applications that are running, environmental changes, and other factors. The fluctuating bandwidth contributes to packet delay and packet loss, thereby ultimately affecting the quality of the media received by the end user. Thus, while a certain streaming bit rate may produce satisfactory output at one point in time during a transmission, that streaming bit rate may later be too high at a subsequent point in time if the wireless channel's bandwidth fluctuates to a lower capacity. Whereas a fluctuating bandwidth may not be as great a problem for the access and display of web pages or downloading of files, such bandwidth changes present a tremendous challenge for the real-time delivery of data when using streaming techniques. If a “thick” video stream is sent over a clogged pipe, the subscriber will see jerky video, or hear pops and clicks in the case of audio.

### BRIEF SUMMARY OF THE INVENTION

One aspect of the present invention provides a method that monitors bandwidth conditions associated with a communication channel. The method determines a delay variation based on data associated with the monitored bandwidth conditions, and uses at least the determined delay variation to decide whether to adapt a bit rate to the bandwidth conditions associated with the communication channel.

### BRIEF DESCRIPTION OF THE SEVERAL VIEWS OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a network in which an embodiment of the invention may be implemented.

FIG. 2 is a block diagram showing components of the network of FIG. 1 in more detail in accordance with an embodiment of the invention.

FIG. 3 is a block diagram of a storage medium that can store an embodiment of a DBA algorithm.

FIG. 4 is a flowchart generally illustrating use of the DBA algorithm in accordance with an embodiment of the invention.

FIG. 5 is a flowchart of a module for analyzing receiver report packet status in accordance with an embodiment of the invention.

FIG. 6 is a flowchart of a module for analyzing delay in accordance with an embodiment of the invention.

FIG. 7 is a graph of an example situation showing delay conditions.

FIG. 8 is a flowchart of a module for analyzing loss in accordance with an embodiment of the invention.

FIG. 9 is a flowchart showing embodiments of bandwidth decision-making and probing modules.

### DETAILED DESCRIPTION

Embodiments of techniques for dynamic bandwidth adaptation are described herein. In the following description, numerous specific details are given to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, one embodiment of the invention allows the streaming of audio or video (A/V) data to be carefully matched to the bandwidth of a channel to a user's (or client's) device. This dynamic bandwidth adaptation comprises two components: (1) the channel's fluctuating bandwidth is monitored, and (2) a streaming server is able to change the streaming bit rate in real time to match or otherwise compensate for variations in the channel's bandwidth. Using this bandwidth monitoring and bit rate adaptation technique, the user is able to receive relatively smoother video and lucid audio.

In accordance with an embodiment of the invention, a dynamic bandwidth adaptation (DBA) algorithm is provided, such as for use with RTP/UDP/IP-based 2.5 G and 3 G wireless video or audio streaming systems as non-exhaustive illustrative examples. The DBA algorithm enables steady streaming quality and smooth transitions during congestion and network resource fluctuation periods. As described below, this feature adapts to the characteristics or conditions of a wireless network (such as a shared packet network) by adjusting the rich media stream to suit the client bandwidth, thereby optimizing the end user experience. The DBA algorithm automatically adjusts the audio and video bit rate being served by a streaming system (which includes the streaming server), based on the end user's available bandwidth in the shared packet network. As such, the end user can receive the most appropriate bit rate stream.

The DBA algorithm provides congestion avoidance and rate control throughout the stream lifetime, by monitoring the channel to each client for statistically significant and persistent changes in the bandwidth that may be associated with packet loss, delay, or delay variation. When these changes occur and when there is an existing closely matching but lower bit rate stream, the streaming server switches over to that lower stream. Switching to a higher bit rate stream may also be performed, if bandwidth conditions improve to allow switching to an optimum higher bit rate transmission. In one embodiment, base delay or delay variation increase tracking information is used to further determine, improve, and optimize bandwidth adaptation in accordance with client device or network/operator requirements.

A specific but non-limiting embodiment provides stream scalability in conjunction with the standards-based MPEG-4 multiple-bit-rate stream format. Switching to a new bit rate stream occurs if that stream has the same content, video resolution, A/V format and color depth, but with a different bit rate (and possibly with a different frame rate). The DBA algorithm can be used for both media-on-demand (MoD) and live broadcast services, as two illustrative and non-exhaustive examples. In an embodiment, the effects of network bandwidth fluctuations on video and audio streams are monitored separately.

In the case of MoD, an mp4 file is generated with multiple bit rate tracks and served from the streaming system. In the case of broadcast, an alias containing different bit rate tracks is used. For both service types, the streaming system switches from one track to another, depending on the available bandwidth.

To illustrate operation of an embodiment of the invention by way of example, assume that a selected content source has 64 kbps, 55 kbps, 45 kbps, 35 kbps, 25 kbps, and 15 kbps bit rates in an mp4 file for a MOD session, and the same set of bit rates can also be streamed by the streaming server in a live broadcast situation. At the start of a stream, the client requests streaming at 52 kbps, for instance. Then, in accordance with an embodiment of the invention:

if the session is a MOD session, the streaming system will start by extracting the 45 kbps stream from the mp4 file and stream it out; and

if the session is a live broadcast session, the streaming system will start by selecting the 45 kbps track coming from a transcoder and stream it out.

Suppose that subsequent bandwidth measurements determine that the bandwidth has changed to 32 kbps, for instance. Then, in accordance with an embodiment of the invention:

if the session is a MOD session, the streaming system will extract the 25 kbps stream from the mp4 file and switch from the 45 kbps stream to the 25 kbps stream; and

if the session is a live/broadcast session, the streaming system will switch from the 45 kbps stream to the 25 kbps stream coming from the transcoder.

In a streaming session, an embodiment of the streaming system selects an appropriate track at the beginning of the session. Then, if the bandwidth drops or increases during the stream, the DBA algorithm will recommend a bit rate adjustment. In making this recommendation, an embodiment of the DBA algorithm factors in statistical and persistent behavior of the channel and does not react to instantaneous spikes. As a result, media quality is not changed abruptly, and bit rate changes happen smoothly and gradually.

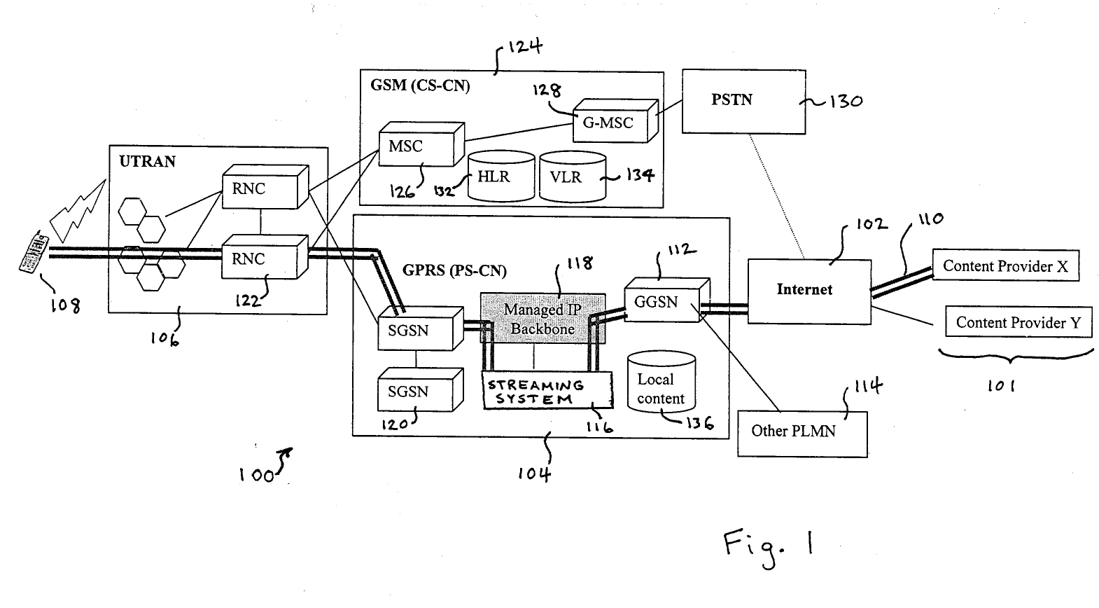

FIG. 1 is a block diagram of a network 100 in which an embodiment of the invention may be implemented. For purposes of explanation only, the network 100 will be described herein in the context of a Universal Mobile Telecommunication System (UMTS) network, which can be used to support 3 G wireless communications. It is appreciated that the UMTS network described herein is not intended to limit the invention—embodiments of the invention may be implemented in other types of wireless communication networks, as a person skilled in the art having the benefit of this disclosure will recognize.

In the network 100, a plurality of content providers 101 (shown as content providers X and Y) provides media content. Examples of such media content include, but are not limited to, real-time media applications that include both video and audio streaming, real-time audio-only applications (such as live music), off-line multimedia applications, off-line audio-only applications, web pages, files, or other type of data that can be made available via an Internet 102.

A general packet radio services (GPRS) system 104 is communicatively coupled to the Internet 102. The GPRS system 104 is communicatively coupled to a UMTS terrestrial radio access network (UTRAN) 106, which provides the cellular sites or other wireless links to wireless client devices 108. The communication of data from the content providers 101 to the client device(s) 108 is represented in FIG. 1 by a double-lined path 110.

The GPRS system 104 is a packet switched core network (PC-CN) in one implementation. The GPRS system 104 includes a gateway GPRS support node (GGSN) 112 communicatively coupled to communicate data with the Internet 102. The GGSN 112 can also be coupled to exchange data with a public land mobile network (PLMN) 114.

One embodiment of a streaming system 116 (which will be described in further detail below) is coupled to the GGSN 112 by way of a managed Internet protocol (IP) backbone 118. The streaming system 116 is coupled to communicate data with the UTRAN 106 by way of one or more serving GPRS support nodes (SGSN) 120 and the managed IP backbone 118. The streaming system 116 includes the various transcoders, streaming server(s), and other components with which an embodiment of the DBA algorithm operates.

The UTRAN 106 includes one or more radio network controllers (RNC) 122 communicatively coupled to the SGSN 120 on one end, and communicatively coupled to the cellular sites and client devices 108 at another end. The client devices 108 include, but are not limited to, cellular telephones, personal digital assistants (PDAs), laptops, personal computers, or other wireless devices or client terminals (including hardwire client terminals in some implementations). The various RNCs 122 and SGSNs 120 can also be communicatively coupled to each other.

The network 100 may also include a global system for mobile communication (GSM) network 124, which in one implementation comprises circuit switched core network (CS-CN). The GSM network 124 includes a mobile switching center (MSC) 126 communicatively coupled to one or more RNCs 122 of the UTRAN 106. The MSC 126 is coupled to a gateway MSC (G-MSC) 128, which in turn is communicatively coupled to a public switched telephone network (PSTN) 130 that can communicate with the Internet 102.

The GSM network 124 includes a home location register (HLR) 132 and a visitor location register (VLR) 134, which are used in connection with roaming operations. The GPRS 104 can include a local content data repository 136, which contains data that can be provided to the client devices 108 alternatively or in addition to data provided from the content providers 101.

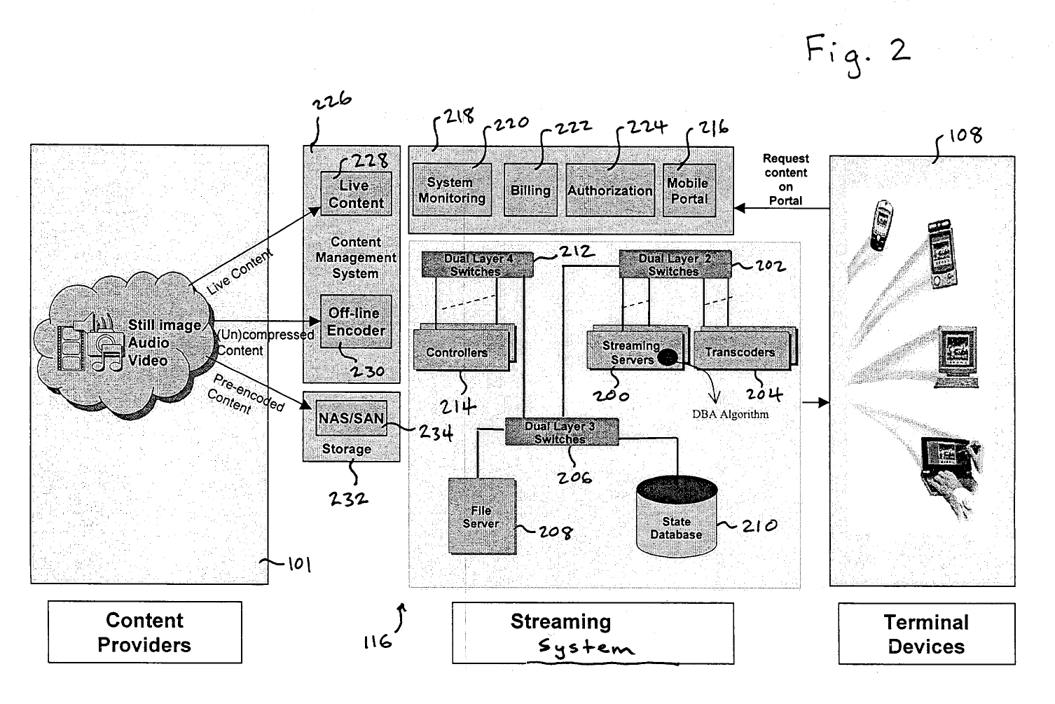

FIG. 2 is a block diagram showing components of the network 100 of FIG. 1 in more detail in accordance with an embodiment of the invention. In particular, FIG. 2 shows an embodiment of the streaming system 116 in greater detail. For the sake of brevity of explanation, FIG. 2 is simplified to show only the relative interaction between the content providers 101, the streaming system 116, and the terminal client devices 108, while the other components of the network 100 of FIG. 1 are not further shown or described in detail.

The content providers 101, as depicted by way of example in FIG. 2, can provide audio, video, or still image media content (as well as other content) in the form of live content, uncompressed content, or pre-encoded content. In one embodiment, the video is in MPEG-4 format, and real-time transport protocol (RTP) is used for streaming, with its accompanying real-time transport control protocol (RTCP) being used for gathering streaming statistics from client devices 108. In one implementation, RTCP receiver report (RR) packets are sent periodically by the client devices 108 to inform the streaming system 116 about the statistics of streaming, which are used by the streaming system 116 to determine whether to adapt in response to a change in bandwidth conditions.

The streaming system 116 includes one or more streaming servers 200 in which the DBA algorithm executes. The streaming server 200 includes a processor that executes the DBA algorithm, which is implemented in one embodiment as software or other machine-readable instruction stored on a machine-readable medium. The streaming server(s) 200 are coupled to dual layer 2 switches 202. A plurality of transcoders 204 is also coupled to the layer 2 switches 202. In an embodiment, the transcoders 204 receive media content that was provided by the content providers 101 under one or more first formats, and then transcode the content to one or more second formats that are compatible with corresponding client devices 108. Example techniques for dynamically transcoding media content from one format to another format are provided by Luxxon Corporation of Mountain View, Calif. (now Vidiator Technology US, Inc.), and are not explained in further detail herein for the sake of brevity.

The layer 2 switches 202 are in turn coupled to dual layer 3 switches 206. A file server 208 and a state database 210 (or other data repository) are coupled to the layer 3 switches 206. The state database 210 or other data repository, coupled to either or both the layer 3 switches 206 or the layer 2 switches 202, can store server load information or other configuration information used for load balancing purposes in an embodiment. The layer 3 switches 206 are coupled to dual layer 4 switches 212. One or more controllers 214 are coupled to the layer 3 switches 212.

When one of the client devices 108 requests delivery of content, the request is received by a mobile portal 216. The mobile portal 216 comprises part of a first subsystem 218, which also includes a system monitoring component 220, a billing component 222, an authorization component 224, or other possible components. The first subsystem 218 can be integrated within the streaming system 116 or it may be separate from it.

The content to be delivered to the requesting client device 108 is provided by the appropriate content provider 101 to a second subsystem 226, which in one embodiment comprises a content management system. The second subsystem 226 includes a live content component 228 to receive live content and an off-line encoder 230 to receive uncompressed content. A storage unit 232 can include a network-attached storage or storage area network (NAS/SAN) component 234 to receive and store pre-encoded content from the content provider(s) 108. The storage unit 232 can be integrated with the second subsystem 226 or can be separate from it.

The content from the content providers 108 is provided by the second subsystem 226 (including the storage unit 232, if appropriate) to appropriate ones of the transcoders 204 by way of the various layer switches 212, 206, and 204 of the streaming system 116. The transcoded output of the appropriate transcoder 204 is then provided to one of the streaming servers 200, via the layer 2 switch 202. That streaming server 200 then streams the transcoded output via the various layer switches 212, 206, and 204 to the requesting client device 108. As will be described below, the bit rate that the streaming server 200 uses to send the transcoded data changes from an initial bit rate to different bit rates, based on changing bandwidth conditions of the communication channel(s) being used.

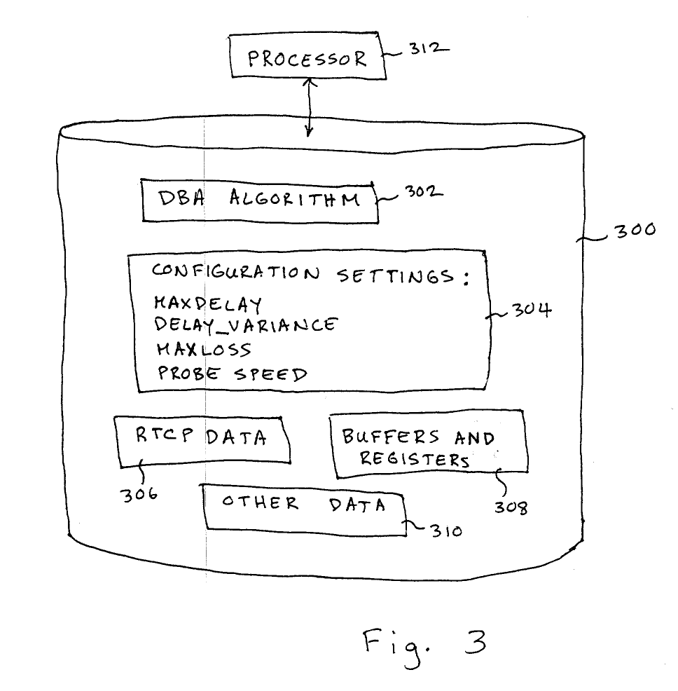

FIG. 3 is a block diagram of a machine-readable storage medium 300 that can store a software program 302 that incorporates an embodiment of the DBA algorithm. The DBA algorithm is part of the server that also resides on 300 in one embodiment. The storage medium 300 can comprise random access memory (RAM), read-only memory (ROM), a hard disk, a compact disk, or other suitable storage medium that can be accessed by a processor of the streaming server 200 (or other processor or controller in the streaming system 116) when executing the DBA algorithm provided by the software program 302.

In one embodiment, the storage medium 300 can also store configuration settings 304. The configuration settings 304 include settings for a maximum delay (MAXDELAY), a delay variance (DELAY_VARIANCE), a maximum loss (MAXLOSS), and probe speed (PROBE_SPEED). The use and relevance of these various configuration settings 304 within the context of the DBA algorithm will be described later below.

In implementations where the DBA algorithm operates in conjunction with RTCP, the storage medium 300 can store RTCP data 306. The RTCP data 306 can include the information that can be obtained directly or computed from RR packets received from client devices 108, including loss, round trip time (used for computing delay), delay variation, and so on. Buffers and registers 308 can contain variable values, calculation results, intermediate values, history information, or other data associated with performing the DBA algorithm. Other data 310 may also be stored in the storage medium 300, which may include data that is alternative or in addition to the data described above. A processor 312 is coupled to the storage medium 300 to execute the DBA algorithm embodied by the software program 302 and to otherwise manage operation of the streaming server 200.

In an embodiment, the (1) status of the RR packets sent via RTCP, (2) delay, and (3) loss are factors that are examined, and bandwidth behavior decisions are made by the DBA algorithm based on the combined state of all of these factors. The DBA algorithm in one example implementation comprises a plurality of software modules or subroutines that can be called for execution whenever each factor is to be examined. Embodiments of the DBA algorithm and its various modules are illustrated in the following flowcharts. In these flowcharts, the various operations need not necessarily occur in the exact sequence shown. Furthermore, some operations may be combined, separated, modified, added, or removed according to various embodiments.

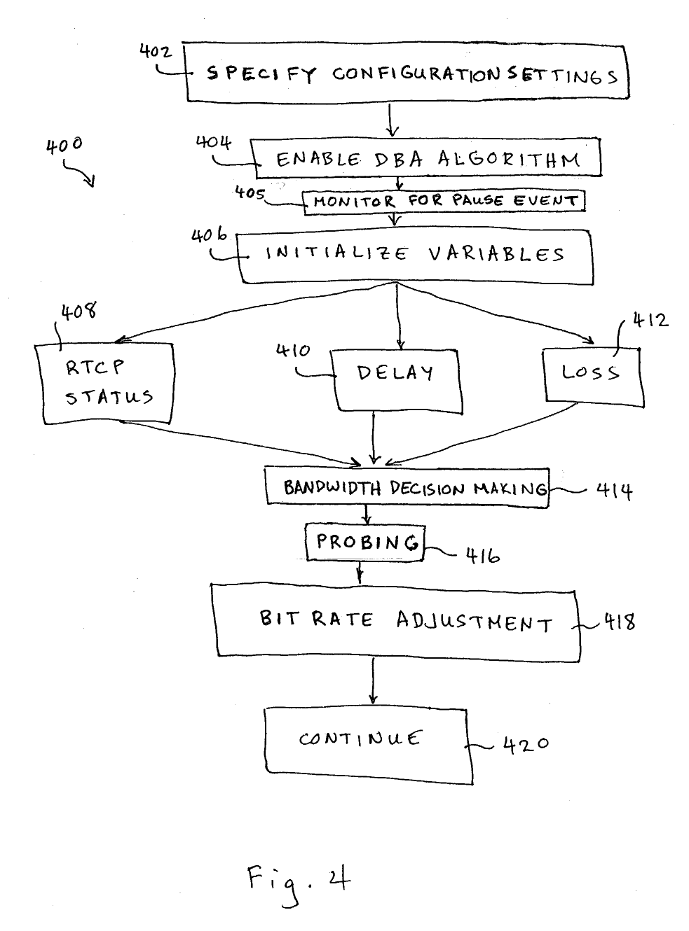

FIG. 4 is a flowchart 400 generally illustrating use of the DBA algorithm in accordance with an embodiment of the invention. At a block 402, the configuration settings 304 are specified. The MAXDELAY setting is the highest tolerable round trip delay value (e.g., delay is measured from the time an RTP packet is sent from the streaming server 200 to the time an RR packet is received at the streaming server 200 from the client terminal 108), which may be specified in milliseconds. An example default value is 20000 ms (20 seconds). If the measured delay is larger than this default value, the DBA algorithm will decrease the bit rate.

The DELAY_VARIANCE setting is the acceptable delay variance, which may be expressed in milliseconds, and represents the amount (difference) in delay between the same bit rates during the same streaming session. Thus as an example, if the delay during a first timeframe of the streaming session for 128 kbps is 200 ms (the base delay), and the delay during a subsequent second timeframe of the streaming session for 128 kbps is 500 ms (the instantaneous delay), then the delay variance is 300 ms (instantaneous delay−base delay). The delay variance is used to determine if a track swap (from one bit rate to another) should be made according to network conditions. If the DELAY_VARIANCE setting is increased, then the DBA algorithm will be more tolerant to large delay variations and will not swap tracks as often. An example default value of DELAY_VARIANCE is 200 ms.

The MAXLOSS setting determines an acceptable packet loss percentage. The higher the number, the more packet loss would be acceptable (and conversely the more the stream will be corrupted without making track swaps). An example default value of MAXLOSS is 1%.

The PROBE_SPEED setting sets the aggressiveness of the DBA algorithm, and is used to help ensure that bit rate adjustments are based on persistent conditions rather than instantaneous spikes. Example settings include: default=4, fastest=1, slowest=N. Probing will be discussed in further detail below.

It is appreciated that configuration settings alternatively or in addition to what is shown in FIG. 3 may also be specified at the block 402. With regards to a default bit rate, such a default rate may be set (for instance at 128 kbps) if there are no other parameters that specify the initial bit rate to be used.

The DBA algorithm is enabled at a block 404, such as by setting an enable bit in the configuration settings 304 to binary 1. A block 405 monitors for the presence of a pause event. One embodiment of this feature guarantees that during a user-initiated pause period (such as when the user chooses to pause the playing of video), loss, delay, and delay variation parameters are adjusted such that any network activity (good or bad) is not reflected on the final streaming statistics. Data during a pause event is not collected, so as to improve the statistical analysis and decision-making process related to actual streaming.

At a block 406, variables used by the DBA algorithm are initialized, such as by setting them to 0, to default values, or to “don't care” X values. Non-exhaustive examples of such variables, relevant ones of which will be explained later below, include (along with their initial settings) the following:

Instantaneous delay (instdelay=0)

Average delay (avgdelay=0)

Total delay (totaldelay=0)

Base delay (basedelay=0)

Previous delay variation (prevdelay_variation=0)

Oldest delay variation (oldestdelaydy_variation=0)

Average delay variation (avgdelay_variation=0)

Total delay variation (totaldelay_variation=0)

Delay status (delay_status=0)

Instantaneous loss (instloss=0)

Previous loss (prevloss=0)

Average loss (avgloss=0)

Total loss (totalloss=0)

Loss status (loss_status=X)

Previous loss status (prevloss_status=X)

Oldest loss status (oldestloss_status=X)

RTCP status (rtcp_status=X).

At blocks 408, 410, and 412, the DBA algorithm respectively examines the RTCP status, delay, and loss. This includes calling the respective modules and having them perform their subroutines using the configuration settings, data obtained from RR packets, historical bandwidth data, or other data. The individual modules represented by the blocks 408, 410, and 412 will be described in further detail in subsequent flowcharts.

In an embodiment, bandwidth decision-making is based on a priority sequential order of RTCP status, then delay, and then loss, where the results of the blocks 408-412 are analyzed at a bandwidth decision-making block 414. A STATUS variable (derived from the results of the blocks 408-412) can represent a “decrease” operation (to decrease the bit rate), an “increase” operation (to increase the bit rate”), or a “NOP” (no operation, where the bit rate is not changed from its current setting). A NOP condition exists, for example, if the results of the DBA algorithm are inconclusive, the DBA algorithm does not have sufficient information to make a recommendation, or if changing the bit rate will not have a sufficiently appreciable effect on streaming performance.

Probing is performed by the DBA algorithm at a block 416 to determine if the RTCP status, delay, or loss results are of a sufficiently persistent nature. If the probing at the block 416 is performed aggressively or is set “fast,” then the DBA algorithm is more likely to recommend bit rate adjustments. Probing affects bit rate increase decisions, whereas bit rate decrease decisions are not changeable through probing decisions in one embodiment. One example embodiment places greater emphasis on conditions to reduce the bit rate, as opposed to conditions to raise the bit rate, since it is often of greater concern to reduce the rate to ensure quality communication, whereas increasing the bit rate relates to an optimization over an existing state.

Bit rate adjustments, if appropriate, are performed at a block 418. The decision whether to make a change in streaming bit rate is based on the value of STATUS variable provided by the DBA algorithm, coupled with probing considerations at the block 416. Bit rate adjustment commands are provided to the streaming server 200 in response to the appropriate values of the STATUS variable.

The DBA algorithm continues at a block 420, which comprises repeating the operations at blocks 408-418 above, including re-initialization of variables at the block 406 if appropriate. The DBA algorithm continues for the life of the streaming session, and can begin again for each new streaming session. The blocks 408-416 can comprise part of the bandwidth-monitoring component of the DBA algorithm, while the block 418 comprises part of its bit rate adaptation component.

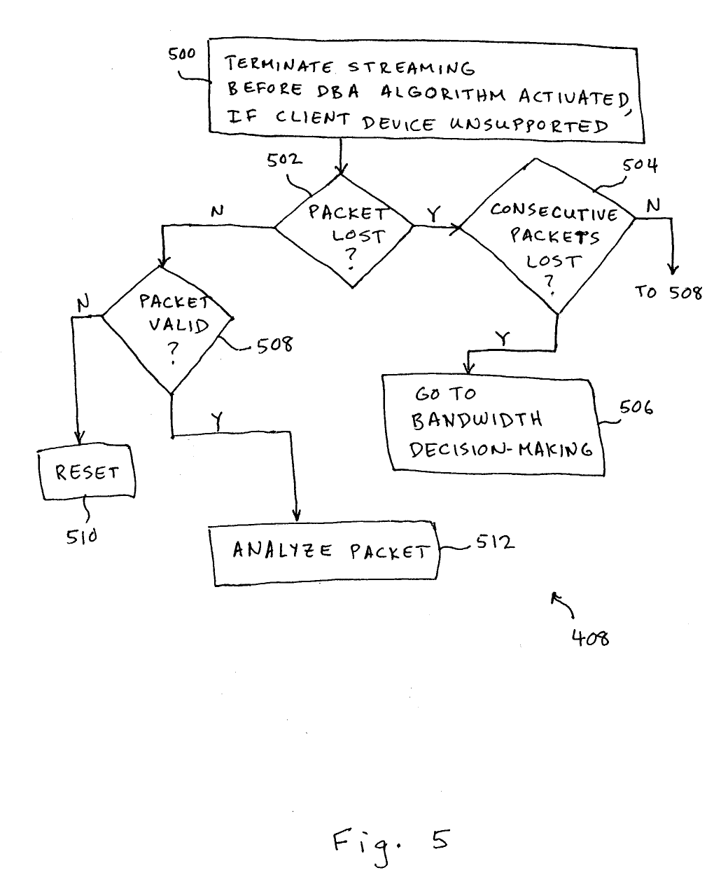

FIG. 5 is a flowchart of a module for analyzing RR packet status in accordance with an embodiment of the invention. More particularly, FIG. 5 shows one embodiment of the RTCP status block 408 of FIG. 4 in more detail.

As described above, RR packets are sent by the client device 108 to the streaming system 116 to provide streaming statistics and other related information. If the client device 108 does not support RTCP RR packets, the streaming server 200 will terminate streaming at a block 500 before the DBA algorithm is activated. In this particular embodiment, the DBA algorithm is based on the assumption that the client device 108 sends RTCP RR packets within an interval of 1-5 seconds, for example.

Even if the client device 108 generates RTCP RR packets, there might be cases where these RR packets are not useful for any analysis. One such case is when the RR packets are lost along the path. In such case, estimation of the available bandwidth can be problematic. However, one deduction that can be made is that, as the loss of RR packets continues, there is some sort of problem in the communication channel. If an RR packet loss is detected at a block 502, then the module proceeds as follows:

If this is the first RR packet that is lost, the module sets an RR loss tracking parameter, and the DBA algorithm is exited until next RR packet arrival. If there are consecutive RR packets that are determined at a block 504 to be lost (using the RR loss tracking parameter to track previous losses), then the module sets rtcp_status=rtcp_not_received, and lets the bandwidth-decision making module (shown at the block 414 of FIG. 4) handle this RR-loss episode at a block 506, which will eventually recommend to the streaming server 200 to decrease the bit rate.

If back at the block 502, there is no RR packet loss detected and the received RR packet is determined to be valid at a block 508, then the module resets the RR loss tracking parameter and sets rtcp_status=X (don't care). The module then proceeds to an RR packet analysis at a block 512, which includes either the delay analysis or loss analysis (at blocks 410 and 412 of FIG. 4, respectively). Similarly, if no consecutive packets are determined to be lost at the block 504, then the current packet is analyzed for validity at the block 508.

At the block 508, there are at least two situations when the received RR packet is considered as not valid:

if rtcp_status=rtcp_not_in_queue, which means that the received RR packet's sequence number does not match with any expected RR packet sequence number (which is derived from the RTP sequence numbers in the sent RTP queue); or

if rtcp_status=rtcp_from_oldbitrate, which means that the received RR packet corresponds to an RTP packet that belonged to a pre-switching bit rate.

If the RR packet is invalid on account of these two situations, then the module resets all tracking parameters (delay, loss, and other statistics) at a block 510, since this is an indication of a break in the DBA flow. Therefore, the DBA algorithm is exited until the next RR packet arrival.

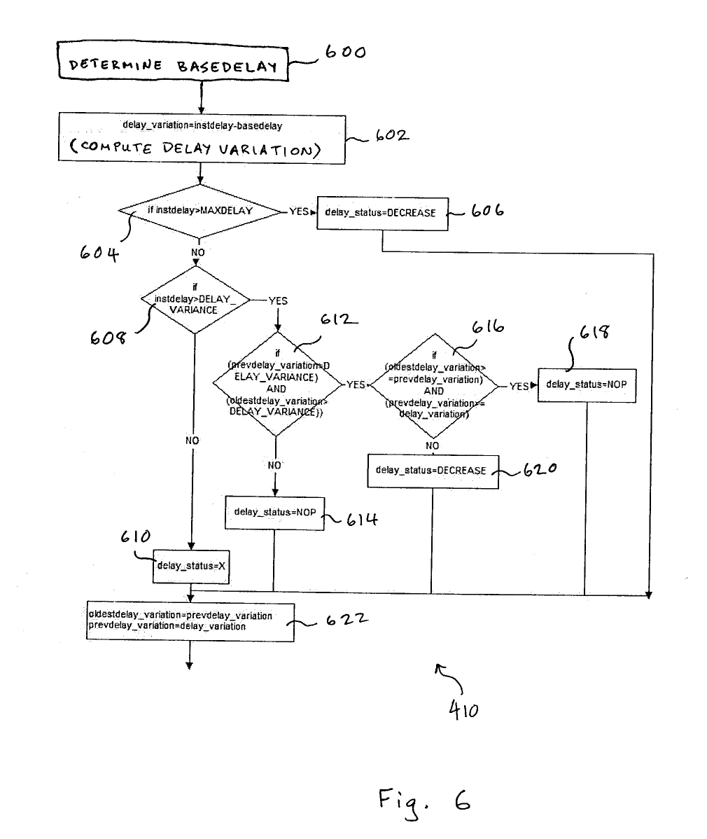

FIG. 6 is a flowchart of a module for analyzing delay in accordance with an embodiment of the invention. In particular, FIG. 6 shows one embodiment of the block 410 of FIG. 4 in more detail. By way of discussion, the “sent time of an RTP packet” and “receive time of a corresponding RR packet” is determinable through server-side time stamping. From these two time stamps, a transport-level round trip delay value, which is called “instdelay,” can be calculated. The DBA algorithm keeps track of the average instdelay, which is called “avgdelay,” throughout the streaming session.

Since avgdelay does not give clear information about per bit-rate delay behavior, the DBA algorithm keeps track of a delay called base delay (“basedelay”). The purpose of basedelay is to identify the optimum observed instdelay for each streamed bit rate. For example, the instdelay for 64 kbps may be 200 ms during a first instance of time, and then bandwidth conditions improve to allow the bit rate to increase to 128 kbps (with a delay of 300 ms at 128 kbps, for instance). Later, the bandwidth is decreased to 64 kbps, but the instdelay is 500 ms. In this example, basedelay is 200 ms for 64 kbps, since it is the minimum delay for that bit rate—this value may be relied upon to be reasonably accurate since it preceded an optimum condition when the bit rate was increased to 128 kbps.

The value of basedelay can be assigned as follows in one example embodiment in a block 600 of FIG. 6; when going up or down in bit rate, the DBA algorithm chooses the minimum for basedelay, in order to remember that this particular bit rate was streamed with a better delay at one point in time. If subsequent avgdelay calculations yield values for that particular bit rate that are better/lower than an initially stored basedelay value, then the avgdelay value becomes the new basedelay value.

At a block 602, the DBA algorithm computes the delay variation using the basedelay value (e.g., delay_variation=instdelay−basedelay). For the subsequent delay analysis in FIG. 6, the DBA algorithm uses the MAXDELAY and DELAY_VARIANCE parameters that are set in the configuration settings 304. MAXDELAY specifies maximum round trip delay that can be tolerated, with a default of 20000 ms (20 seconds) as an example, whereas DELAY_VARIANCE specifies maximum delay variance that can be tolerated with a default value of 200 ms, as an example.

At a block 604, if instdelay>MAXDELAY, then a variable called “delay_status”=decrease. This condition indicates a major delay problem, since the instantaneous delay is greater than the maximum threshold that was set for MAXDELAY, and therefore favors a decrease in the current bit rate at a block 606.

If the MAXDELAY value is not exceeded at the block 604, then a block 608 determines whether delay_variation is greater than the maximum value specified by DELAY_VARIANCE. If this condition is not met, then delay_status=X (don't care) at a block 610, since no significant delay variation is observed.

However, if there is a significant delay variation at the block 608, then the DBA algorithm checks two previous conditions (the previous delay variation, and the delay variation previous to that, called “oldestdelay_variation”) to understand the delay behavior. Specifically at a block 612, if prevdelay_variation>DELAY_VARIANCE) and if oldestdelay_variation>DELAY_VARIANCE conditions are not met, then delay_status=NOP at a block 614. This means that the delay conditions have varied and are not sufficiently persistent or significant to warrant further analysis to determine if the bit rate should be reduced.

However, if the conditions are met at the block 612, then at a block 616, the following conditions are examined:

oldestdelay_variation≧prevdelay_variation and prevdelay_variation≧delay_variation. If these conditions are met, then delay_status=NOP at a block 618. If these conditions are not met (being indicative of an undesirable delay fluctuation), then delay_status=decrease at a block 620.

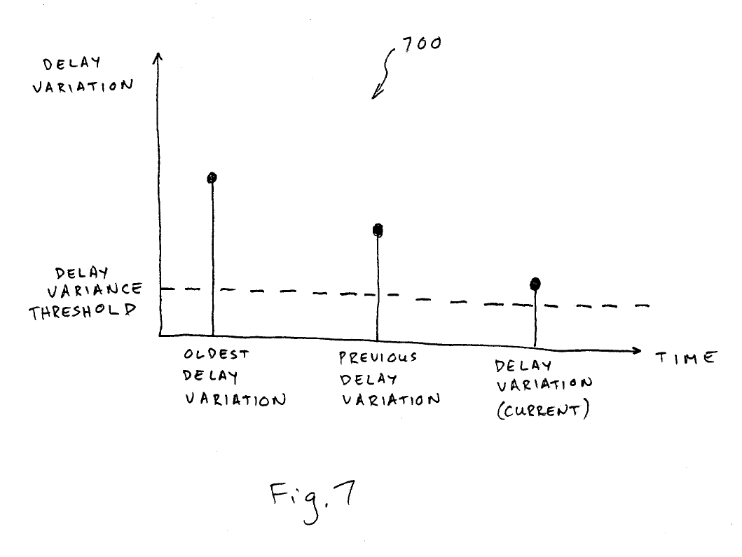

At a block 622, the variables are reset to provide a “moving window” for examining the history of delay variations for subsequent delay analysis. FIG. 7 is a graph 700 of an example situation showing delay conditions. In this example, the delay conditions are improving, but are still sufficiently significant since the delay variations exceed the DELAY_VARIANCE threshold.

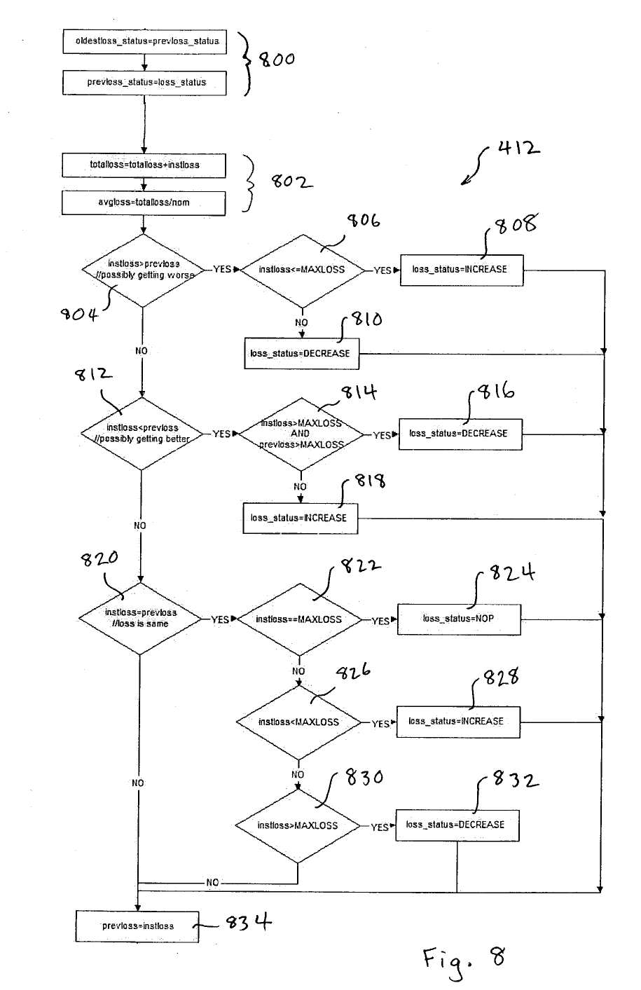

FIG. 8 is a flowchart of a module for analyzing loss in accordance with an embodiment of the invention. More particularly, FIG. 8 shows one embodiment of the block 412 of FIG. 4 in more detail. An “instloss” variable represents the instantaneous fractional loss information extracted from each RR packet received from the client device 108. For loss analysis, the DBA algorithm uses the MAXLOSS parameter that was provided in the configuration settings 304. MAXLOSS specifies the upper limit loss (such as a percentage) that can be tolerated, with a default value of 1% as an example.

At blocks 800 in FIG. 8, certain variables representing instantaneous, previous, and oldest loss status are initialized:

oldestloss_status=prevloss_status

prevloss_status=loss_status.

At blocks 802, the total loss is computed based on the instantaneous loss, and the average loss is computed based on the instantaneous loss, where “nom” is the total number of measurements:

totalloss=totalloss+instloss

avgloss=totalloss/nom.

At a block 804, if the instantaneous loss is greater than the previously measured loss (instloss>prevloss), then this indicates that loss might possibly be getting worse. If it is determined at a block 806 that instloss≦MAXLOSS, then a variable called “loss_status”=increase at a block 808, which indicates that loss conditions are sufficiently optimum to consider increasing the bit rate. However, if the instantaneous loss is greater than the MAXLOSS threshold at the block 806, then loss_status=decrease at a block 810, which indicates that loss conditions are sufficiently poor and consideration of bit rate decrease is warranted

If instloss<prevloss at a block 812, then loss is possibly getting better. At a block 814, if instloss>MAXLOSS and prevloss>MAXLOSS, then loss_status=decrease is set at a block 816, since these results indicate poor loss conditions and therefore require consideration of a bit rate decrease. Otherwise, loss_status=increase is set at a block 818, signifying that the bit rate may be increased.

If instloss=prevloss at a block 820, then loss is the same as in a previous analysis. If instloss=MAXLOSS at a block 822, then loss_status=NOP is set at a block 824, since the loss percentage is at a boundary.

If instloss<MAXLOSS at a block 826, then loss_status=increase is set at a block 828, since the loss is still below the set threshold. If instloss>MAXLOSS at a block 830, then loss_status=decrease is set at a block 832, since the loss is above the set threshold. The variable prevloss is set to instloss at a block 834 to provide the moving window for subsequent loss analysis.

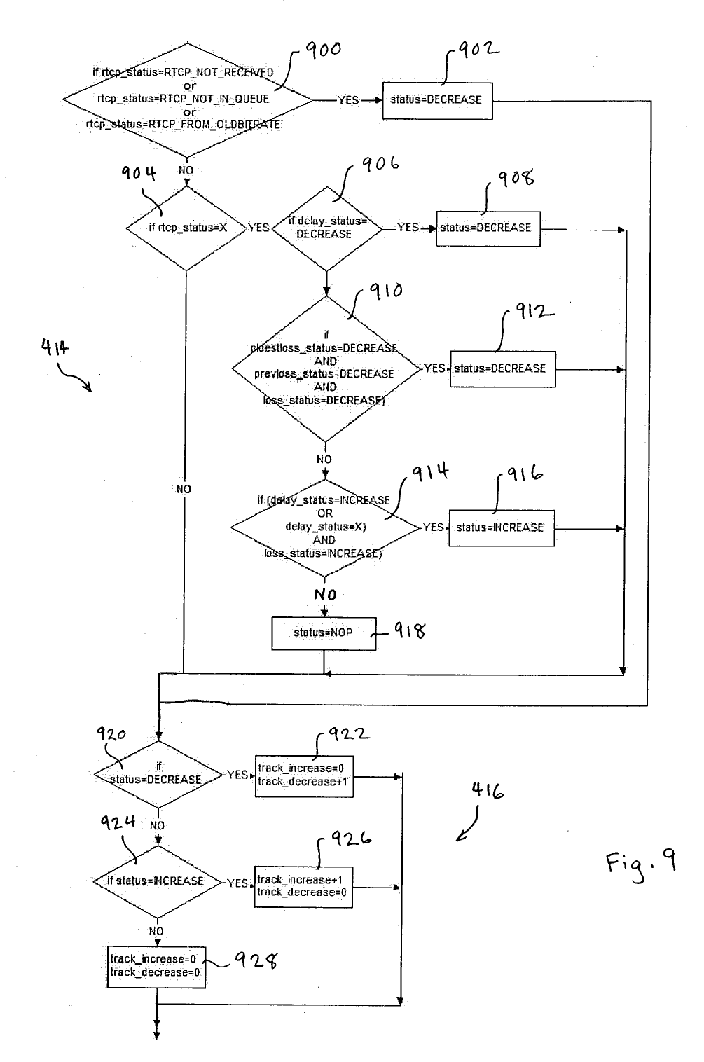

FIG. 9 is a flowchart showing embodiments of the bandwidth decision-making block 414 and the probing block 416 of FIG. 4 in more detail. At a block 900, the state of the rtcp status variable (from the results of the RTCP status block 408 depicted in detail in FIG. 5) is examined. If rtcp_status=rtcp_not_received (indicative of lost RR packets), then STATUS=decrease is set at a block 902. In an embodiment, this is the only RTCP status that will trigger a decrease in bit rate. In another embodiment, invalid RR packets (e.g., rtcp_status=rtcp_not_in_queue or rtcp_status=rtcp_rom_oldbitrate) can also trigger a decrease in bit rate.

If rtcp status=X at a block 904 and if delay_status=decrease (from the results of the delay analysis block 410 shown in detail in FIG. 6) at a block 906, then STATUS=decrease is set at a block 908. However, if at a block 910, oldestloss_status=decrease and prevloss_status=decrease and loss_status=decrease (from the results of the loss analysis block 412 shown in detail in FIG. 8), then STATUS=decrease is set at a block 912.

If at a block 914, delay_status=increase or delay_status=X and loss_status=increase, then STATUS=increase is set at a block 916. Otherwise, STATUS=NOP is set at a block 918.

In one embodiment, the DBA algorithm tracks the persistence of any decrease or increase in bandwidth before any action is taken, so that instantaneous spikes are avoided. Thus, even though variables such as RTCP_status, delay_status, loss_status, and others generate values/results that provide recommendations to other modules or processes of the DBA algorithm as to whether to increase, reduce, or maintain the current bit rate, the bit rate is not yet actually changed in response to these recommendations in an embodiment until the recommendations are collectively considered (by the decision-making block 414, for instance) and/or until some degree of persistence is ascertained or tracked. Such tracking is performed at the probing block 416, an embodiment of which is shown in more detail in FIG. 9.

Even though the DBA algorithm knows the instantaneous bandwidth STATUS, an embodiment still tracks the persistence of bandwidth behavior (a variable called “final_status”)and adjusts the amount of bandwidth changes before suggesting any changes to an A/V bit rate switching module of the streaming server 200. Consecutive increase and decreases are tracked as follows:

If STATUS=decrease at a block 920, then variables track_decrease=track_decrease+1 and track_increase=0 are set at a block 922. If STATUS=increase at a block 924, then track_increase=track_increase+1 and track_decrease=0 are set at a block 926. Otherwise, track_increase=0 and track_decrease=0 are set at a block 928.

There are two threshold values for tracking consecutive increase and consecutive decreases: threshold_increase is set to FAST_INCREMENT and threshold_decrease is set to FAST_DECREMENT. Minimum example values for FAST_INCREMENT is 2 and for FAST_DECREMENT is 1. This means, for instance, for an increase in bandwidth to be considered sufficiently significant, two consecutive STATUS=increase decisions need to arrive. Current, previous, and pre-previous states (RR packets) are examined for increase or decrease decisions that makes 3 RR packets for each status update. For each final_status update this makes 4 RR packets for increases and 3 RR packets for decreases.

The number of RR packets observed for any decision-making at the block 414 has a direct on the speed and stability of the whole algorithm. The probe_speed is a user configurable parameter that adjusts the FAST_INCREMENT value. The bit-rate increment/probing speed can be adjusted, while the same parameters are used for decreases (i.e., decrease parameters are not adjustable in one embodiment).

Pₛ is the actual number of consecutive RTCP packets needed for a bit rate increase decision and Dₛ is the actual number of consecutive RTCP packets needed for a bit rate decrease decision (see tables below for examples).

| | FAST_IN- | FAST_DE- | | |
|---|---|---|---|---|
| Probe_speed (s) | CREMENT | CREMENT | Pₛ | Dₛ |
| 1 (fastest) | 2 | 1 | 4 | 3 |
| 2 (default) | 3 | 1 | 5 | 3 |
| 3 | 4 | 1 | 6 | 3 |
| 4 | 5 | 1 | 7 | 3 |
| 5 | 6 | 1 | 8 | 3 |
| 6 | 7 | 1 | 9 | 3 |
| 7 | 8 | 1 | 10 | 3 |
| 8 | 9 | 1 | 11 | 3 |
| . | . | . | . | . |
| . | . | . | . | . |
| . | . | . | . | . |
| N (slower) | . | . | . | . |
| . | . | . | . | . |
| . | . | . | . | . |

Pₛ and Dₛ values for various probing speeds

| | For | For | For |
|---|---|---|---|
| Probe_speed (s) | δ = 1 sec, Tₛ | δ = 3 sec, Tₛ | δ = 5 sec, Tₛ |
| 1 (fastest) | 3 sec | 9 sec | 15 sec |
| 2 (default) | 4 sec | 12 sec | 20 sec |
| 3 | 5 sec | 15 sec | 25 sec |
| 4 | 6 sec | 18 sec | 30 sec |
| 5 | 7 sec | 21 sec | 35 sec |
| 6 | 8 sec | 24 sec | 40 sec |
| 7 | 9 sec | 27 sec | 45 sec |
| 8 | 10 sec | 30 sec | 50 sec |
| : | : | : | : |
| N (slower) | : | : | : |

Tₛ value for sample δ values and probe speeds

The minimum expected duration between two probes is Tₛ where s is the user selected probing speed,

Tₛ=(Pₛ−1)*δ,

where δ is the minimum RTCP interarrival in seconds.

For example if s=2 (from the table Pₛ=4) and min_RTCP_interarrival=3 seconds then Tₛ=(4−1)*3=9 seconds.

Note that Tₛ is the minimum expected duration between two probes. This duration can be prolonged by many external factors such as changing network conditions, lost RTCP packets, and others.

The bit rate adjustment at the block 418 of FIG. 4 can be performed using a number of techniques to select the most appropriate new bit rate. In an live broadcast session, a selected source from one of the transcoders 204 of FIG. 2 can be sent to the streaming server 200 as S simultaneous on-line stream with a bit rate of rᵢ for each stream, where 1<i<S and rᵢ=rⱼ only if i=j. In an off-line MoD session, S simultaneous streams with rᵢ bit-rates for each stream are written into a multi-bit rate mp4 file to be used by the streaming server 200 off-line. If Bₐ is the initial streaming bit rate, at change of bitrate from value Bₐ to value B_{new}, Bₛ is taken into consideration, where Bₛ is the suggested bandwidth by DBA algorithm. The streaming server 200 will start extracting the new size bite stream from the multi-bit-rate mp4 file, if the streaming session is a MoD session. In the case of a live broadcast session, the streaming server 200 will start by selecting a Bₐ_{_{—}}_{new} such that,

if|Bₛ−rᵢ₊₁|≦1 kbps Bₐ_{_{—}}_{new}=rᵢ₊₁

else Bₐ_{_{—}}_{new}=rᵢ.

The stream switching happens substantially smoothly and seamlessly without contributing to end-to-end delay or jitter. If some jitter is introduced, then there are two types of buffers present at the client device 108 that can smooth it out: socket buffer and decoder buffer. The socket buffer is set to a large amount and is thus not a bottleneck. The decoder buffer is a user configurable play-out buffer of K seconds, 0≦K≦20, where the default value is set to 5 seconds, for instance. Streaming does not start until the decoder buffer is filled.

One factor that may affect how quickly the DBA algorithm responds to bandwidth changes, is the granularity (distance between tracks) of the streams in the multiple bit rate mp4 file, or the alias in the live broadcast. If the granularity is coarse, one example embodiment of the DBA algorithm may be less sensitive and less responsive. If the granularity is fine, one example embodiment of the DBA algorithm will be more sensitive and more responsive. However, finer granularity would mean more streams in the mp4 file, which will impact system resources. On the other hand, the bit rate recommendations made by an embodiment of the DBA algorithm do not depend on the order of the bit rate tracks present in the multiple bit rate mp4 file or the alias. Rather, the streaming system 116 can switch from one bit rate track to a track best suited for the available bandwidth, and in the process, possibly bypassing tracks that are closer to the previous stream. Also, if the client device 108 does not specify a bit rate, the stream bit rate can go as high as network resources allow. If, however, the client device 108 specifies a bit rate, one embodiment of the DBA algorithm can use the specified value as the ceiling for the stream bit rate.

In one example implementation, the amount of bandwidth increase performed by the DBA algorithm is set at 40%, for situations where tracks of an mp4 file are at a maximum 40% apart. An example bandwidth decrease is 5%. In another embodiment, the DBA algorithm can progressively swap to each available bit rate in sequence, either upwards or downwards, in response to bandwidth fluctuations, without necessarily making bit rate changes based on percentage amounts.

An embodiment of the DBA algorithm can also generate three quality of service (QoS) parameters that can be used to assess the network or streaming performance:

average packet loss (%)

average delay (ms)

average delay variation (ms)

$$avgloss = \frac{1}{n} {\sum }_{i = 1}^{n} {loss}_{i} ,$$

where loss is the percentage of one-way data packet loss determined over each RTCP generation period.

$$avgdelay = \frac{1}{n} {\sum }_{i = 1}^{n} {delay}_{i} ,$$

where delay is the round trip delay for each packet, where delay=rtp₁₃ send_timestamp−rtcp_receive_timestamp; and delay variance

$${s}^{2} = \frac{1}{n - 1} \sum {( {delay}_{i} - avgdelay )}^{2} .$$

An embodiment of the DBA algorithm may be used in conjunction with several standards. Non-exhaustive examples are listed as follows:

1. MPEG-4 by ISO/IEC JTC1/SC29/WG11.

2. IETF RFC 3016: RTP Payload Format for MPEG-4

Audio/Visual Streams, Kikuchi, Y. Nomura, T., Fukunaga, S., Matsui, Y., Kimata, H., November 2000.

3. IETF RFC 1889: RTP: A Transport Protocol for Real-Time Applications, H. Schulzrinne, S. Casner, R. Frederick, V. Jacobson. January 1996.

4. IETF RFC 2757: Long Thin Networks, G. Montenegro, S. Dawkins, et al., January 2000.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention and can be made without deviating from the spirit and scope of the invention.

For example, while specific wireless communication standards, formats, or protocols are described herein, it is appreciated that these are merely provided as examples. Embodiments of the invention may be provided for use with other wireless communication standards, formats, protocols, or implementation.

As another example, embodiments have been described herein for use in wireless communication networks, since wireless communication networks are more error prone and exhibit more bandwidth fluctuation as compared to wired communication networks. However, it is appreciated that other embodiments of the invention may be implemented in wired communication networks or in hybrid wired-wireless communication networks, where it is desired to optimize communication of data in response to changing conditions of communication channels.

As yet another example, the various embodiments of the DBA algorithm are described with respect to using certain variable labels, formats, and values. These variable labels, formats, and values may be modified in other embodiments.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
monitoring bandwidth conditions associated with a communication channel;
determining a delay variation based on data associated with the monitored bandwidth conditions; and
using at least the determined delay variation to determine whether to adapt a bit rate to the bandwidth conditions associated with the communication channel.

2. The method of claim 1 wherein monitoring the bandwidth conditions associated with the communication channel comprises monitoring bandwidth conditions associated with a wireless communication channel.

3. The method of claim 1 wherein determining the delay variation comprises:
determining a base delay;
subtracting the base delay from an instantaneous delay to obtain a value for the delay variation.

4. The method of claim 1, further comprising:
using receiver report status information to additionally determine whether to adapt the bit rate to the bandwidth conditions; and
using loss information to additionally determine whether to adapt the bit rate to the bandwidth conditions.

5. The method of claim 4 wherein using the receiver status information to additionally determine whether to adapt the bit rate to the bandwidth conditions include:
determining if consecutive receiver packets have been lost, and recommending a decrease in the bit rate if consecutive receiver packets have been lost; and
determining if received receiver packets are valid.

6. The method of claim 4, further comprising recommending decrease of the bit rate if at least one of a maximum delay, a delay variance, and a maximum loss has been exceeded.

7. The method of claim 6, further comprising if the delay variance is exceeded:
recommending decrease of the bit rate, if previous delay and oldest delay variations are greater than the delay variance, and if the oldest delay variation is not greater than or equal to the previous delay variation or if the previous delay variation is not greater than or equal to the determined delay variation; and
maintaining a current bit rate otherwise.

8. The method of claim 6, further comprising:
if an instantaneous loss is greater than a previous loss, a) recommending an increase of the bit rate if the instantaneous loss is less than or equal to the maximum loss, and b) recommending a decrease of the bit rate otherwise;
if the instantaneous loss is less than the previous loss, a) recommending a decrease of the bit rate if the instantaneous loss is greater than the maximum loss and if the previous loss is greater than the maximum loss, and b) recommending an increase of the bit rate otherwise; and
if the instantaneous loss is substantially equal to the previous loss, a) maintaining a current bit rate if the instantaneous loss is substantially equal to the maximum loss, b) recommending an increase of the bit rate if the instantaneous loss is less than the maximum loss, and c) recommending a decrease of the bit rate if the instantaneous loss is greater than the maximum loss.

9. The method of claim 1, further comprising:
recommending whether to adjust the bit rate based on a delay variance status result, a receiver report status result, and loss status result; and
tracking the status results; and
adjusting the bit rate if consecutive status results that provide a same recommendation are present.

10. The method of claim 1 wherein adapting the bit rate to the bandwidth conditions comprises adapting a bit rate of a video stream.

11. An article of manufacturing, comprising:
a machine-readable medium having processor-executable instructions stored thereon to:
monitor bandwidth conditions associated with a communication channel;
compute a delay variation based on data associated with the monitored bandwidth conditions; and
use at least the computed delay variation to determine whether to adapt a bit rate to the bandwidth conditions associated with the communication channel.

12. The article of manufacture of claim 11 wherein the instructions to compute the delay variation include instructions to:
determine a base delay;
subtract the base delay from an instantaneous delay to obtain a value for the delay variation.

13. The article of manufacture of claim 11 wherein the machine-readable medium further includes instructions stored thereon to:
use receiver report status information to additionally determine whether to adapt the bit rate to the bandwidth conditions; and
use loss information to additionally determine whether to adapt the bit rate to the bandwidth conditions.

14. The article of manufacture of claim 13 wherein the machine-readable medium further includes instructions stored thereon to:
track status results associated with the delay variance, receiver report status information, and loss information; and
instruct a change in the bit rate if the tracked status results are indicative of persistent bandwidth conditions associated with the communication channel.

15. A system, comprising:
a means for monitoring bandwidth conditions associated with a communication channel;
a means for determining a delay variation based on data associated with the monitored bandwidth conditions; and
a means for using at least the determined delay variation to determine whether to adapt a bit rate to the bandwidth conditions associated with the communication channel.

16. The system of claim 15, further comprising:
a means for using receiver report status information to additionally determine whether to adapt the bit rate to the bandwidth conditions; and
a means for using loss information to additionally determine whether to adapt the bit rate to the bandwidth conditions.

17. The system of claim 15, further comprising:
a probing means for tracking status results associated with the delay variance, receiver report status information, and loss information; and
a means for instructing a change in the bit rate based on whether the tracked status results are indicative of persistent bandwidth conditions associated with the communication channel.

18. The system of claim 15, further comprising:
a means for providing media content;
a means for receiving the media content, including means for transcoding the media content and for sending the transcoded media content to client devices.

19. The system of claim 15, further comprising a means for storing an algorithm and associated data related to the means for monitoring the bandwidth conditions and for determining the delay variation.

20. The system of claim 15, further comprising a means for determining an amount of bit rate change.

21. A system, comprising:
a plurality of transcoders to receive media content and to transcode the media content into different formats at different bit rates;
at least one streaming server coupled to the plurality of transcoders to send the content at a particular bit rate to a client terminal; and
a storage medium having a software algorithm to monitor bandwidth conditions associated with a communication channel, compute a delay variation based on data associated with the monitored bandwidth conditions, and use at least the computed delay variation to recommend whether to change the bit rate to another bit rate provided the streaming server.

22. The system of claim 21 wherein the software algorithm includes:
code to use receiver report status information to additionally determine whether to adapt the bit rate to the bandwidth conditions; and
code to use loss information to additionally determine whether to adapt the bit rate to the bandwidth conditions.

23. The system of claim 21 wherein the software algorithm includes code to compute the delay variation based on an instantaneous delay and a base delay.

24. The system of claim 21 wherein the software algorithm includes code to determine if bandwidth conditions are persistent prior to recommendation of a change to another bit rate provided by the streaming server.

25. The system of claim 21 wherein the software algorithm includes code to change the bit rate if values associated with at least one of a maximum loss, delay variance, and maximum delay has been exceeded.

26. The system of claim 21 wherein the media content comprises at least one of live broadcast content and media-on-demand content.

27. The system of claim 26 wherein the contents comprise video content.

28. The system of claim 21 wherein the software algorithm includes code to separately monitor bandwidth fluctuations associated with video content and audio content streams.

29. The system of claim 21 wherein the software algorithm includes code to generate quality of service parameters.

30. The system of claim 21 wherein the software algorithm includes code to not collect data associated with bandwidth conditions during a pause event.
